(19) United States
(12) Patent Application Publication
(10) Pub. No.: US 2015/0143523 A1
(43) Pub. Date: May 21, 2015

(54) VIRUS PROCESSING METHOD AND APPARATUS

(71) Applicant: BAIDU ONLINE NETWORK TECHNOLOGY (BEIJING) CO., LTD., Beijing (CN)

(72) Inventors: Mingqiang Guo, Beijing (CN); Keming Qian, Beijing (CN); Liang Cao, Beijing (CN); Jinfeng Pan, Beijing (CN); Zhiqiang Dong, Beijing (CN)

(73) Assignee: BAIDU ONLINE NETWORK TECHNOLOGY (BEIJING) CO., LTD., Beijing (CN)

(21) Appl. No.: 14/533,062

(22) Filed: Nov. 4, 2014

(30) Foreign Application Priority Data
Nov. 19, 2013 (CN) 2013105833695

(51) Int. Cl. H04L 29/06

(52) U.S. Cl. CPC H04L 63/1416; H04L 63/1441
USPC 726/24

(57) ABSTRACT

Embodiments of the present disclosure provide a virus processing method and apparatus. In embodiments of the present disclosure, attribute analysis on the threads contained in the target process is performed to determine whether at least one of the threads contained in the target process matches virus attribute information. If at least one of the threads contained in the target process matches virus attribute information, virus type information is determined based on the matched virus attribute information, so that execution of process creation operation is prohibited based on the virus type information. Due to the measures of prohibiting execution of process creation operation, replication of virus in the system can be effectively prevented so as to improve security performance of the system.

### RELATED APPLICATIONS

The present application claims the priority of the Chinese patent application having Serial No. 2013105833695, entitled “Virus processing method and apparatus”, filed on Nov. 19, 2013.

### FIELD

The present disclosure relates to computer technologies, and particularly to a virus processing method and apparatus.

### BACKGROUND

Virus is data programmed or inserted in an application to destroy computer functions. It can affect normal use of the application and replicate itself, and usually appears in the form of a group of instructions or program codes. Virus is characterized by destructiveness, complexity, and infectivity. When a file in a system is infected with virus, an anti-virus engine is necessary to scan the system and remove the virus. Since the virus is highly replicable, activated virus may attempt to infect other files in the system so that it is difficult for anti-virus software to thoroughly eradicate the virus out of the system.

### SUMMARY

Several aspects of the present disclosure provide a virus processing method and apparatus to improve the security performance of the system.

According to an aspect of the present disclosure, there is provided a virus processing method, comprising steps of:

performing attribute analysis on at least one of threads contained in a target process to determine whether at least one of the threads contained in the target process matches virus attribute information;

if at least one of the threads contained in the target process matches virus attribute information, determining virus type information based on the matched virus attribute information;

prohibiting execution of process creation operation based on the virus type information.

According to the above aspect and any possible implementation, there is further provided an implementation, wherein the step of performing attribute analysis on at least one of threads contained in a target process to determine whether at least one of the threads contained in the target process matches virus attribute information comprises:

obtaining a name of the target process and/or a Hash value of the name;

obtaining attribute information of the threads contained in the target process;

performing a matching operation over a virus attribute library based on the name of the target process and/or the Hash value of the name and the attribute information of the threads contained in the target process, so as to determine whether at least one of threads contained in the target process matches virus attribute information contained in the virus attribute library.

According to the above aspect and any possible implementation, there is further provided an implementation, wherein after the step of prohibiting execution of process creation operation based on the virus type information, the method further comprises:

determining a first file run by the target process corresponding to said at least one thread;

performing a repair operation on the first file based on the virus type information to generate a second file, whose file name comprises a preset or randomly-generated repair identifier; and

performing a replicate operation on the second file to generate a third file, whose file name is identical to that of the first file.

According to the above aspect and any possible implementation, there is further provided an implementation, wherein after performing a replicate operation on the second file to generate a third file, the method further comprises:

instructing system to execute a restart operation; and

deleting the second file.

According to the above aspect and any possible implementation, there is further provided an implementation, wherein the step of prohibiting execution of process creation operation based on the virus type information comprises:

determining whether or not to enter into a safe repair mode based on the virus type information;

generating a notification event upon determining to enter into the safe repair mode;

prohibiting execution of the process creation operation based on the notification event.

According to another aspect of the present disclosure, there is provided a virus processing apparatus, comprising:

an analyzing unit configured to perform attribute analysis on at least one of threads contained in a target process to determine whether at least one of the threads contained in the target process matches virus attribute information;

a determining unit configured to determine virus type information based on the matched virus attribute information if at least one of the threads contained in the target process matches virus attribute information;

an operating unit configured to prohibit execution of process creation operation based on the virus type information.

According to the above aspect and any possible implementation, there is further provided an implementation, wherein the determining unit is specifically configured to

obtain a name of the target process and/or a Hash value of the name;

obtain attribute information of the threads contained in the target process; and

perform a matching operation over a virus attribute library based on the name of the target process and/or the Hash value of the name and the attribute information of the threads contained in the target process, so as to determine whether at least one of threads contained in the target process matches virus attribute information contained in the virus attribute library.

According to the above aspect and any possible implementation, there is further provided an implementation, wherein the apparatus further comprises a repair unit configured to

determine a first file run by the target process corresponding to said at least one thread;

perform a repair operation on the first file based on the virus type information to generate a second file, whose file name comprises a preset or randomly-generated repair identifier; and

perform a replicate operation on the second file to generate a third file, whose file name is identical to that of the first file.

According to the above aspect and any possible implementation, there is further provided an implementation, wherein the repair unit is further configured to

instruct system to execute a restart operation; and

delete the second file.

According to the above aspect and any possible implementation, there is further provided an implementation, wherein the operating unit is specifically configured to

determine whether or not to enter into a safe repair mode based on the virus type information;

generate a notification event upon determining to enter into the safe repair mode; and

prohibiting execution of the process creation operation based on the notification event.

According to another aspect of the present disclosure, there is provided a computer readable storage medium comprising a computer readable program, wherein the computer readable program when executed on a computer causes the computer to perform the steps of:

performing attribute analysis on at least one of threads contained in a target process to determine whether at least one of the threads contained in the target process matches virus attribute information;

if at least one of the threads contained in the target process matches with virus attribute information, determining virus type information based on the matched virus attribute information;

prohibiting execution of process creation operation based on the virus type information.

As can be seen from the above technical solutions, in embodiments of the present disclosure, attribute analysis on the threads contained in the target process is performed to determine whether at least one of the threads contained in the target process matches virus attribute information. If at least one of the threads contained in the target process matches virus attribute information, virus type information is determined based on the matched virus attribute information, so that execution of process creation operation is prohibited based on the virus type information. Due to the measures for prohibiting execution of process creation operation, replication of virus in the system can be effectively prevented so as to improve security performance of the system.

Besides, with the technical solution provided by the present disclosure, the attribute analysis is no longer performed with the file as a whole unit, but performed with each thread contained in the target process as a unit. Since granularity of the attribute analysis is reduced, the security performance of the system can be further improved.

### BRIEF DESCRIPTION OF THE DRAWINGS

To illustrate the technical solutions in the embodiments of the present disclosure or the prior art more clearly, accompanying drawings for description of the embodiments or the prior art are briefly introduced hereinafter. Obviously, the accompanying drawings in the following description are merely some embodiments of the present disclosure. One of ordinary skill in the art may further obtain other drawings based on these drawings without creative efforts.

FIG. 1 illustrates a flowchart of a virus processing method according to an embodiment of the present disclosure;

FIG. 2 illustrates a schematic structure view of a virus processing apparatus according to another embodiment of the present disclosure;

FIG. 3 illustrates a schematic structure view of a virus processing apparatus according to a further embodiment of the present disclosure.

### DETAILED DESCRIPTION OF EMBODIMENTS

To give a clearer picture of the purposes, technical solutions, and advantages of the embodiments of the present disclosure, the technical solutions of the embodiments of the present disclosure are clearly and completely described with accompanying drawings for the embodiments of the present disclosure. Evidently, the embodiments to be described are some, rather than all, of the embodiments of the present disclosure. All other embodiments obtained by one of ordinary skill in the art based on the embodiments of the present disclosure without creative efforts fall within the protection scope of the present disclosure.

Moreover, the term “and/or” herein merely describes associated relationship between related objects. It indicates that three types of relationship may exist, for example, A AND/OR B may represent three cases: only A exists, both A AND B exist, and only B exists. In addition, the symbol “/” herein generally represents an “or” relationship between related objects juxtaposed by the symbol “/”.

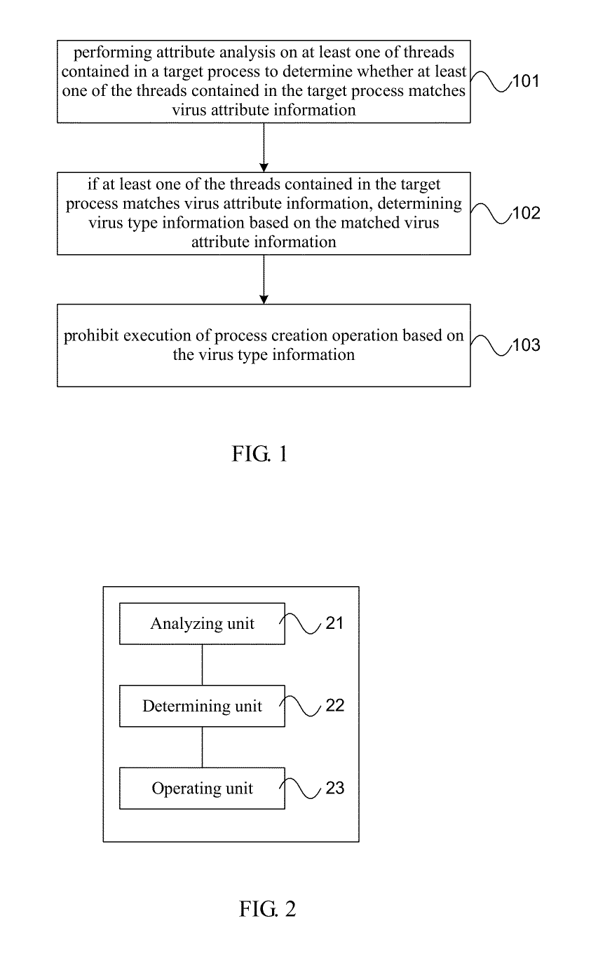

FIG. 1 illustrates a flowchart of a virus processing method according to an embodiment of the present disclosure. FIG. 1 shows:

Step 101: performing attribute analysis on at least one of threads contained in a target process, so as to determine whether at least one of the threads contained in the target process matches virus attribute information.

In the above step, the target process may be understood as all processes in a system.

Step 102: if at least one of the threads contained in the target process matches virus attribute information, determining virus type information based on the matched virus attribute information.

Specifically, process information such as the process name, thread name, thread state, and thread behavior of each process may be obtained by traversing the processes in the system by using a snapshot method.

Step 103: prohibiting execution of process creation operation based on the virus type information.

In the above step, virus, also called computer virus, may include, but not limited to, Trojan, backdoor, local area network worm, mail worm, spyware, infectious virus, or Rootkits/Bootkits.

Noticeably, the subject for executing step 101-step 103 may be an anti-virus engine, which may be located in a local client to perform offline operation for virus removal, or located in a network-side server to perform online operation for virus removal. The present embodiment is not limited to this.

It may be appreciated that the client may be an application installed on a terminal or a web page of a browser or any objective existing form, so long as it can remove the virus to provide a safe system environment. The present embodiment is not limited to this.

In this way, attribute analysis on the threads contained in the target process is performed to determine whether at least one of the threads contained in the target process matches virus attribute information. If at least one of the threads contained in the target process matches virus attribute information, virus type information is determined based on the matched virus attribute information, and execution of process creation operation is prohibited based on the virus type information. Due to the measures of prohibiting execution of process creation operation, replication of virus in the system can be effectively prevented so as to improve security performance of the system.

Optically, in a possible implementation of the present embodiment, in step 101, an anti-virus engine may specifically obtain the name of the target process and/or a Hash value of the name. The anti-virus engine then obtains attribute information of the threads contained in the target process. The anti-virus engine may then perform a matching operation over a virus attribute library based on the name of the target process and/or a Hash value of the name and the attribute information of the threads contained in the target process, so as to determine whether at least one of threads contained in the target process matches virus attribute information contained in the virus attribute library.

The attribute information may include dynamic attributes and/or static attributes. The dynamic attributes may be understood as virus identifying criterion based on virus behavior, and the static attributes may be understood as virus identifying criterion based on attribute codes of virus.

Specifically, the virus attribute library stores information related to virus attribute information, including, but not limited to, process identifiers (e.g., the name of the target process and/or the Hash value of the name), thread attribute information and identifiers (ID) of the virus attribute information. This is particularly defined in the present disclosure.

For example,

Specifically, the virus engine may perform a first matching operation over the virus attribute library based on the name of the target process and/or the Hash value of the name to determine whether at least one of the target processes matches with the name of one of the processes contained in the virus attribute library.

In the event of successful matching in the first matching operation, the anti-virus engine may further perform a second matching operation over the virus attribute library based on the attribute information of the threads contained in the matched target process to determine whether at least one of the threads contained in the matched target process matches with the virus attribute information corresponding to the target process contained in the virus attribute library. In the case no match is found, the anti-virus engine may further perform a third matching operation over the virus attribute library based on the attribute information of the threads contained in the matched target process to determine whether at least one of the threads contained in matched target process matches virus attribute information contained in the virus attribute library other than the virus attribute information corresponding to the target process.

In the event of unsuccessful matching in the first matching operation, the anti-virus engine may further perform a second matching operation over the virus attribute library based on the attribute information of the threads contained in the target process, so as to determine whether at least one of threads contained in the target processes matches virus attribute information contained in the virus attribute library.

Furthermore, after step 102, the anti-virus engine may further determine to perform operation on said at least one thread and instruct a process management unit to, for example, suspend the thread or stop the thread.

Optionally, the anti-virus engine in the present embodiment may further perform initialization processing for the virus attribute library in advance. Specifically, the anti-virus engine may perform initialization processing for the virus attribute library according to a startup order of the processes.

Optionally, in a possible implementation of the present embodiment, the anti-virus engine may specifically deliver the matched virus attribute information with mask codes. Below are some examples.

In step 101, when each thread is matched with corresponding virus attribute information contained over the virus attribute library, the anti-virus engine records a virus attribute code, and then the anti-virus engine performs an OR operation on the recorded virus attribute codes sequentially to obtain a return value. Specifically, the anti-virus engine may specifically store the return value into a global variable.

Specifically, the virus attribute code may be 4 bytes in a virus code and might contain two or three instructions, or may be bytes of other number in the virus code. The present embodiment is not particularly limited to this.

In step 102, the anti-virus engine performs an AND operation according to the return value obtained in step 101 to obtain the virus attribute code.

Optionally, in a possible implementation of the present embodiment, after step 103, the anti-virus engine may specifically determine a first file run by the target process corresponding to said at least one thread. Then, the anti-virus engine may perform a repair operation on the first file based on the virus type information to generate a second file, and a file name of the second file includes a preset or randomly-generated repair identifier. The anti-virus engine may then perform a repair operation on the second file to generate a third file, and a file name of the third file is identical to that of the first file.

Specifically, the anti-virus engine may upload a dedicated anti-virus engine based on the determined virus type information, and perform a repair operation on the first file based on the virus type information. The second file is a file generated after the repair of the first file and is already a file not infected with the virus, if the second file is still given a file name identical to that of the first file, the dedicated anti-virus engine will perform scanning and virus-killing on it again and again, entering into an endless loop. With the technical solution of the present disclosure, the endless loop of the dedicated anti-virus loop can be effectively prevented.

Correspondingly, the anti-virus engine may subsequently instruct system to execute a restart operation. And during the restart of the system or after the system restarts, the anti-virus engine may delete the second file. For example, the anti-virus engine may set a deletion-delay mark bit. When the deletion-delay mark bit is true, the anti-virus engine may instruct the system to perform the restart operation, and then determine the second file according to the repair identifier and delete it. When the deletion-delay mark bit is not true, the anti-virus engine may generate a notification event and send the notification event to the drive to notify the drive to get into a normal state where it no longer prohibits execution of process creation operation.

Optionally, in a possible implementation of the present embodiment, in step 103, the anti-virus engine may specifically determine whether or not to enter into a safe repair mode based on the virus type information. Upon determining to enter into the safe repair mode, the anti-virus engine may generate a notification event and send the notification event to notify prohibition of the execution of the process creation operation.

Specifically, if the virus indicated by the virus type information has a single-process resident property, the anti-virus engine may employ a method in prior art and directly suspend or stop the relevant thread; if the virus indicated by the virus type information has a multi-process resident property, the anti-virus engine may pop up a dialog box to query the user whether or not to enter into the safe repair mode. For example, the content in the pop-up dialog box reads “anti-virus tip: a tough xxx virus being found, please switch to the safe repair mode for thorough virus checking and killing, and you cannot operate other applications during the repair”.

If the user clicks a “confirm” button, the anti-virus engine generates a notification event and sends the notification event to the drive to notify the drive to prohibit the execution of process creation operation; if the user clicks a “cancel” button, the anti-virus engine may employ a method in prior art and directly suspend or stop the relevant thread.

In the present embodiment, attribute analysis is performed for threads contained in the target process, so as to determine whether at least one of the threads contained in the target process matches virus attribute information. If at least one of the threads contained in the target process matches virus attribute information, the virus type information is determined based on the matched virus attribute information, and execution of process creation operation is prohibited based on the virus type information. Due to the measures for prohibiting execution of process creation operation, replication of the virus in the system can be effectively prevented so as to improve security performance of the system.

Besides, with the technical solution provided by the present disclosure, the attribute analysis is no longer performed with the file as a whole unit, but performed with each thread contained in the target process as a unit. Since granularity of the attribute analysis is reduced, the security performance of the system can be further improved.

Noticeably, the above-mentioned embodiments all are described as a combination of a series of actions for the sake of simple description, but those skilled in the art know that the present disclosure is not limited to the described order of actions, because some steps may be performed in any other order or simultaneously according to the present disclosure. Moreover, those skilled in the art appreciate that embodiments described in the description all belong to preferred embodiments, and none of the involved actions or modules is a must for the present disclosure.

The above embodiments are each described from different viewpoints, and a portion not detailed in a certain embodiment may find relevant depictions in other embodiments.

FIG. 2 illustrates a schematic structure view of a virus processing apparatus according to another embodiment of the present disclosure. As shown in FIG. 2, the virus processing apparatus according to the present embodiment may include an analyzing unit 21, a determining unit 22, and an operating unit 23.

In the aforementioned apparatus, the analyzing unit 21 is configured to perform attribute analysis on at least one of threads contained in a target process to determine whether at least one of the threads contained in the target process matches virus attribute information, wherein the target process may be understood as all processes in the system.

The determining unit 22 is configured to determine virus type information based on the matched virus attribute information in the case that at least one of the threads contained in the target process matches virus attribute information. Specifically, the determining unit 22 may specifically obtain process information such as the process name, thread name, thread state, and thread behavior of each process by traversing the processes in the system using a snapshot method.

The operating unit 23 is configured to prohibit execution of process creation operation based on the virus type information, wherein virus, also called computer virus, may include, but not limited to, Trojan, backdoor, local area network worm, mail worm, spyware, infectious virus or Rootkits/Bootkits.

Noticeably, the virus processing apparatus according to the present embodiment may be an anti-virus engine which may be located in a local client to perform offline operation for virus removal, or located in a network-side server to perform online operation for virus removal. The present embodiment is not limited to this.

It may be appreciated that the client may be an application installed on a terminal or a web page of a browser or any objective existing form, so long as it can remove the virus to provide a safe system environment. The present embodiment is not limited to this.

In this way, the analyzing unit performs attribute analysis on the threads contained in the target process, so as to determine whether at least one of the threads contained in the target process matches virus attribute information, then if at least one of the threads contained in the target process matches virus attribute information, the determining unit determines the virus type information based on the matched virus attribute information so that the operating unit can prohibit execution of process creation operation based on the virus type information. Due to the measures of prohibiting execution of process creation operation, replication of virus in the system can be effectively prevented so as to improve security performance of the system.

Optically, in a possible implementation of the present embodiment, the determining unit 22 may specifically be used to obtain the name of the target process and/or a Hash value of the name; obtain attribute information of the threads contained in the target process; and perform a matching operation over a virus attribute library based on the attribute information of the threads contained in the target process, so as to determine whether at least one of threads contained in the target process matches virus attribute information contained in the virus attribute library.

The attribute information may include dynamic attributes and/or static attributes. The dynamic attributes may be understood as virus identifying criterion based on virus behavior, and the static attributes may be understood as virus identifying criterion based on virus attribute codes.

Specifically, the virus attribute library stores information related to virus attribute information, including, but not limited to, process identifiers (e.g., the name of the target process and/or the Hash value of the name), thread attribute information and identifiers (ID) of virus attribute information. This is particularly defined in the present disclosure.

For example,

Specifically, the determining unit 22 may specifically perform a first matching operation over the virus attribute library based on the name of the target process and/or the Hash value of the name to determine whether at least one of the target processes matches with the name of one of the processes contained in the virus attribute library.

In the event of successful matching, the determining unit 22 may further perform a second matching operation over the virus attribute library based on the attribute information of the threads contained in the matched target process to determine whether at least one of the threads contained in the matched target process matches with the virus attribute information corresponding to the target process contained in the virus attribute library. In the case of no matching, the determining unit 22 may further perform a third matching operation over the virus attribute library based on the attribute information of the thread contained in the matched target process to determine whether at least one of the threads contained in the matched target process matches with virus attribute information contained in the virus attribute library other than the virus attribute information corresponding to the target process.

In the event of unsuccessful matching, the determining unit 22 may further perform a second matching operation over the virus attribute library based on the attribute information of the threads contained in the target process, so as to determine whether at least one of the threads contained in the target process matches virus attribute information contained in the virus attribute library.

Furthermore, after step 102, the determining unit 22 may further determine to perform operation on said at least one thread and instruct a process management unit to, for example, suspend the thread or stop the thread.

Optionally, in a possible implementation of the present embodiment, the virus processing apparatus may further perform initialization processing for the virus attribute library in advance. Specifically, initialization processing is performed for the virus attribute library according to a startup order of the processes.

Optionally, in a possible implementation of the present embodiment, the virus processing apparatus (for example, the analyzing unit 21, the determining unit 22, and the operating unit 23) may specifically deliver the matched virus attribute information with mask codes. Below are some examples.

When each thread matches virus attribute information contained in the virus attribute library, the analyzing unit 21 may record a virus attribute code, and then the analyzing unit 21 performs an OR operation on the recorded virus attribute codes sequentially to obtain a return value. Specifically, the analyzing unit 21 may specifically store the return value into a global variable.

Specifically, the virus attribute code may be 4 bytes in a virus code and might contain two or three instructions, or may be bytes of any other number in the virus code. The present embodiment is not limited to this particularly.

The determining unit 22 performs an AND operation according to the return value obtained by the analyzing unit 21 to obtain the virus attribute code.

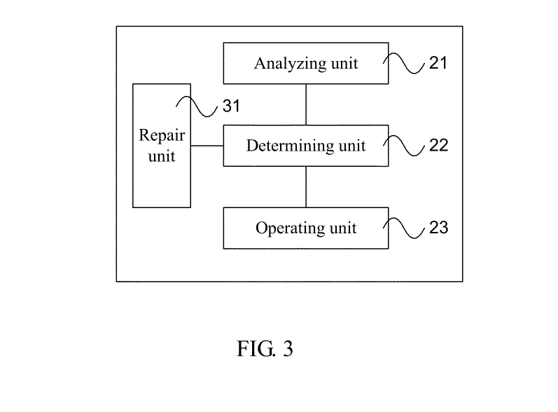

Optionally, in a possible implementation of the present embodiment, the virus processing apparatus according to the present embodiment as shown in FIG. 3 may further comprise a repair unit 31 configured to determine a first file run by the target process corresponding to said at least one thread; then perform a repair operation on the first file based on the virus type information to generate a second file, whose file name comprises a preset or randomly-generated repair identifier; and perform a replicate operation on the second file to generate a third file, whose file name is identical to that of the first file.

Specifically, the repair unit 31 may specifically upload a dedicated anti-virus engine based on the virus type information determined by the determining unit 22, and perform the repair operation on the first file based on the virus type information. The second file is a file generated after the repair of the first file and is already a file not infected with the virus, if the second file is still given a file name identical to that of the first file, the dedicated anti-virus engine will perform scanning and virus-killing for it again and again, entering into an endless loop. With the technical solution of the present disclosure, the endless loop of the dedicated anti-virus loop can be effectively prevented.

Correspondingly, the repair unit 31 may further instruct system to execute a restart operation; and delete the second file. Specifically, during the system restart or after the system restart, the repair unit 31 may delete the second file. For example, the repair unit 31 may set a deletion-delay mark bit. When the deletion-delay mark bit is true, the repair unit 31 may instruct the system to perform a restart operation, and then determine the second file according to the repair identifier and delete it. When the deletion-delay mark bit is not true, the repair unit 31 may generate a notification event and send the notification event to the drive to notify the drive to enter into a normal state wherein it no longer prohibits execution of process creation operation.

Optionally, in a possible implementation of the present embodiment, the operating unit 23 may specifically determine whether or not to enter into a safe repair mode based on the virus type information; generate the notification event upon determining to enter into the safe repair mode; and send the notification event to notify prohibition of the execution of the process creation operation.

Specifically, if the virus indicated by the virus type information has a single-process resident property, the operating unit 23 may employ a method in prior art and directly suspend or stop the relevant thread; if the virus indicated by the virus type information has a multi-process resident property, the operating unit 23 may pop up a dialog box to query the user whether or not to enter into the safe repair mode. For example, the content in the pop-up dialog box reads “anti-virus tip: a tough xxx virus being found, please switch to the safe repair mode for thorough virus checking and killing, and you cannot operate other applications during the repair”.

If the user clicks a “confirm” button, the operating unit 23 generates the notification event and sends the notification event to the drive to notify the drive to prohibit execution of process creation operation; if the user clicks a “cancel” button, the operating unit 23 may employ a method in prior art and directly suspend or stop the relevant thread.

In the present embodiment, the analyzing unit performs attribute analysis on the threads contained in the target process, so as to determine whether at least one of the threads contained in the target process matches virus attribute information, then if at least one of the threads contained in the target process matches virus attribute information, the determining unit determines the virus type information based on the matched virus attribute information so that the operating unit prohibits execution of process creation operation based on the virus type information. Due to the measures for prohibiting execution of process creation operation, replication of virus in the system can be effectively prevented so as to improve security performance of the system.

Besides, with the technical solution provided by the present disclosure, the attribute analysis is no longer performed with the file as a whole unit, but performed with each thread contained in the target process as a unit. Since granularity of the attribute analysis is reduced, the security performance of the system can be further improved.

Those skilled in the art may clearly understand that, for ease and concision of description, for a specific working process of the foregoing described system, apparatus, and unit, reference may be made to a corresponding process in the foregoing method embodiments, and details are not repeatedly described here.

In the several embodiments provided in this application, it should be understood that, the disclosed system, apparatus, and method may be implemented by other manners. For example, the foregoing described apparatus embodiment is only exemplary. For example, dividing of the units is only a type of dividing of logical functions. In actual implementation, there may be other dividing methods. For example, a plurality of units or components may be combined or integrated into another system, or some attributes may be ignored, or may not be executed. In addition, the illustrated or discussed mutual coupling, or direct coupling, or communication connection may be implemented through some interfaces, and indirect coupling or communication connection of apparatuses or units may be electrical, mechanical, or in other forms.

The units that are described as separate components may be or may not be physically separated, and the components shown as units may be or may not be physical units, that is, may be located at one place, or may also be distributed on multiple network units. Part of or all of the units may be selected, according to an actual need, to achieve the purposes of the solutions in the embodiments.

In addition, function units in each embodiment of the present disclosure may be integrated into a processing unit, and each unit may also exist independently and physically, and two or more than two units may also be integrated into one unit. The foregoing integrated unit may be implemented in the form of hardware, and may also be implemented in the form of hardware plus a software function unit.

The foregoing integrated unit implemented in the form of the software function unit may be stored in a computer readable storage medium. The software function unit is stored in a storage medium, including several instructions used for a computer device (which may be a personal computer, a server, or a network device, and so on) and a processor to execute part of the steps of the method in each embodiment of the present disclosure. The foregoing storage medium includes various media that can store procedure codes, such as a USB disk, a portable hard disk, a read only memory (Read-Only Memory, abbreviated as ROM), a random access memory (Random Access Memory, abbreviated as RAM), a magnetic disk, or a compact disk.

Finally, it should be noted that: The foregoing embodiments are only intended to explain the technical solutions in the present disclosure, but not intended to limit them. Although the present disclosure is described in detail with reference to the foregoing embodiments, one of ordinary skill in the art should understand that, they may still make modifications to the technical solutions recorded in the foregoing embodiments, or equivalent replacements to part of the technical features in the technical solutions recorded in the foregoing embodiments; however, these modifications or replacements do not make the nature of the corresponding technical solutions depart from the spirit and scope of the technical solutions in the embodiments of the present disclosure.

What is claimed is:

1. A virus processing method, wherein the method comprises steps of:
performing attribute analysis on at least one of threads contained in a target process to determine whether at least one of the threads contained in the target process matches virus attribute information;
if at least one of the threads contained in the target process matches virus attribute information, determining virus type information based on the matched virus attribute information;
prohibiting execution of process creation operation based on the virus type information.

2. The method according to claim 1, wherein the step of performing attribute analysis on at least one of threads contained in a target process to determine whether at least one of the threads contained in the target process matches virus attribute information comprises:
obtaining a name of the target process and/or a Hash value of the name;
obtaining attribute information of the threads contained in the target process;
performing a matching operation over a virus attribute library based on the name of the target process and/or the Hash value of the name and the attribute information of the threads contained in the target process, so as to determine whether at least one of threads contained in the target process matches virus attribute information contained in the virus attribute library.

3. The method according to claim 1, wherein after the step of prohibiting execution of process creation operation based on the virus type information, the method further comprises:
determining a first file run by the target process corresponding to said at least one thread;
performing a repair operation on the first file based on the virus type information to generate a second file, whose file name comprises a preset or randomly-generated repair identifier; and
performing a replicate operation on the second file to generate a third file, whose file name is identical to that of the first file.

4. The method according to claim 3, wherein after performing a replicate operation on the second file to generate a third file, the method further comprises:
instructing a system to execute a restart operation; and
deleting the second file.

5. The method according to one of claim 1, wherein the step of prohibiting execution of process creation operation based on the virus type information comprises:
determining whether or not to enter into a safe repair mode based on the virus type information;
generating a notification event upon determining to enter into the safe repair mode;
prohibiting execution of the process creation operation based on the notification event.

6. A virus processing apparatus, wherein the apparatus comprises:
an analyzing unit configured to perform attribute analysis on at least one of threads contained in a target process to determine whether at least one of the threads contained in the target process matches virus attribute information;
a determining unit configured to determine virus type information based on the matched virus attribute information in the case that at least one of the threads contained in the target process matches virus attribute information;
an operating unit configured to prohibit execution of process creation operation based on the virus type information.

7. The apparatus according to claim 6, wherein the determining unit is configured to
obtain a name of the target process and/or a Hash value of the name;
obtain attribute information of the threads contained in the target process; and
perform a matching operation over a virus attribute library based on the name of the target process and/or the Hash value of the name and the attribute information of the threads contained in the target process, so as to determine whether at least one of threads contained in the target process matches virus attribute information contained in the virus attribute library.

8. The apparatus according to claim 6, wherein the apparatus further comprises a repair unit configured to
determine a first file run by the target process corresponding to said at least one thread;
perform a repair operation on the first file based on the virus type information to generate a second file, whose file name comprises a preset or randomly-generated repair identifier; and
perform a replicate operation on the second file to generate a third file, whose file name is identical to that of the first file.

9. The apparatus according to claim 8, wherein the repair unit is further configured to
instruct a system to execute a restart operation; and
delete the second file.

10. The apparatus according to one of claim 6, wherein the operating unit is specifically configured to
determine whether or not to enter into a safe repair mode based on the virus type information;
generate a notification event upon determining to enter into the safe repair mode; and
prohibiting execution of process creation operation based on the notification event.

11. A computer readable storage medium comprising a computer readable program, wherein the computer readable program when executed on a computer causes the computer to perform the steps of:
performing attribute analysis on at least one of threads contained in a target process to determine whether at least one of the threads contained in the target process matches virus attribute information;
if at least one of the threads contained in the target process matches with virus attribute information, determining virus type information based on the matched virus attribute information;
prohibiting execution of process creation operation based on the virus type information.
